(19) United States
(12) Patent Application Publication
(10) Pub. No.: US 2009/0080067 A1
(43) Pub. Date: Mar. 26, 2009

(54) PDP Filter for Absorbing Near Infrared Ray

(76) Inventors: Yeon Keun Lee, Daejeon (KR); Su Rim Lee, Daejeon (KR); Sang Hyun Park, Daejeon (KR); Hyun Seok Choi, Seoul (KR); Jung Doo Kim, Daejeon (KR)

Correspondence Address: MCKENNA LONG & ALDRIDGE LLP, 1900 K STREET, NW, WASHINGTON, DC, 20006, US

(21) Appl. No.: 12/226,773

(22) PCT Filed: Feb. 5, 2008
(86) PCT No.: PCT/KR2008/000732

§ 371 Date: Oct. 28, 2008

(30) Foreign Application Priority Data
Feb. 8, 2007 (KR) 10-2007-0013420

(51) Int. Cl. G02B 5/22; G02B 1/00

(52) U.S. Cl. 359/359; 359/350; 252/587

(57) ABSTRACT

There is provided a PDP filter for absorbing near infrared ray capable of significantly reducing the kind and amount of dyes that are used to block a near infrared ray (NIR) emitted from PDP, the filters having physical properties that are improved when compared to conventional PDP filters for absorbing near infrared ray in which a large amount of 2, 3 or more dyes are used to block wide NIR spectra. The PDP filter includes a dye whose maximum absorption wavelength to a near infrared ray ranges from 880 to 1000 nm, and preferably from 900 to 960 nm. The PDP filter can be useful to improve its productivity, reduce the manufacturing cost and prevent the decrease in the light transmittance by unnecessary dyes.

### TECHNICAL FIELD

The present invention relates to a plasma display panel (PDP) filter for absorbing near infrared ray, and more particularly, to a PDP filter capable of significantly reducing the kind and amount of dyes that are used as filters to block a near infrared ray (NIR) emitted from PDP, the filters having physical properties that are improved when compared to conventional PDP filters for absorbing near infrared ray in which a large amount of 2, 3 or more dyes are used to block wide NIR spectra.

### BACKGROUND ART

As shown in FIG. 1, electromagnetic waves having wavelengths of various bands are generated from a PDP surface, and one of the electromagnetic waves is a near infrared ray (hereinafter, simply referred to as ‘NIR’). The term ‘near infrared ray’ refers to an electromagnetic wave having long wavelengths that are in the proximity to wavelengths of the infrared rays. Generally, an electromagnetic wave having a wavelength range from about 800 to 1000 nm is emitted from the PDP.

However, the near infrared ray has a wavelength range that is overlapped with operating wavelengths of a remote controller that is used to operate household electronic equipment, for example audio devices, air conditioners, videos, TV, etc. As a result, the near infrared ray emitted from the PDP may cause erroneous operation of the electronic equipment, and therefore the emission of the near infrared ray from the PDP surface should be necessarily prevented in an active manner.

For this purpose, a PDP filter attached to the PDP surface includes a near infrared absorption layer. Here, the near infrared absorption layer is manufactured in the form of a film including a dye that can absorb a wavelength range of a near infrared ray emitted from the PDP surface together with a base material, or in the form of a sputter film in which silver, ITO and the like are deposited alternately as a thin film.

A PDP filter includes an antireflective layer, an electromagnetic wave shielding layer, a near infrared shielding layer, a color correction layer, etc. Each of these functional layers may be used as a separate film, or used in the form of a complex film in which at least two functions are incorporated into a single film. When each of the functional layers is used as a separate film, products become more complex, and an additional process is required to attach the functional layers to each other. Therefore PDP filter manufacturers have attempted to simplify the products through the unification of various functions into one film.

In order to cut down the manufacturing cost through the simplification of the PDP filter, there is a method for providing additional functions to a polymeric pressure sensitive adhesive (PSA) that has been essentially used to attach films to each other. Products in which PSA includes a color-correcting dye have been commonly used in the related art, and there have also been many attempts to incorporate a near infrared absorption dye into PSA.

Recently, most near infrared ray films made of a near infrared absorption dye includes a diimmonium-based dye having excellent visible ray transmittance and shielding a near infrared ray of a relatively wider wavelength range (from 900 to 1100 nm), and produced so that a dye, which absorbs a wavelength range of 850 nm, can cover the wavelength range of the diimmonium-based dye that lacks its absorption characteristics. However, the diimmonium-based dye has vulnerable durability, and therefore its durability should be maintained in a binder having a glass transition temperature (Tg) of 80° C. or above. Therefore, binders that may be used herein are hampered by a variety of restrictions, and the durability of the diimmonium-based dye is very unstable in the PSA having Tg of 0° C. or below.

Accordingly, a near infrared ray film that does not include the diimmonium-based dye needs to be developed so as to simplify a PDP filter by incorporating an NIR layer into a PSA layer without coating a separate base material with a binder having Tg of 80° C. or above. However, because other near infrared ray dyes, except for the diimonium-based dye, have a disadvantage that they have a relatively narrower absorption wavelength range, a near infrared shielding region needs to be minimized and focused in consideration of its efficiency according to the wavelengths when the other near infrared ray dyes are used as a PDP filter.

As an example of the above-mentioned filter for absorbing a near infrared ray of a wavelength range of 800 to 1000 nm, Japanese Patent Laid-open Publication No. 2004-309655 discloses a filter for absorbing a near infrared ray including phthalocyanine I having the maximum absorption wavelength of 800 to 920 nm and phthalocyanine II having the maximum absorption wavelength at 920 nm or greater. Also, the phthalocyanine I or the phthalocyanine II is subdivided into at least two phthalocyanines having the maximum absorption wavelength in the narrow wavelength range, depending on the operating wavelength bands. A variety of the dyes as disclosed in the Japanese Patent Laid-open Publication No. 2004-309655 are used because no dye that can absorb a wide wavelength range has been reported up to now.

However, when a filter is manufactured as disclosed in the Japanese Patent Laid-open Publication No. 2004-309655, the manufacturing process may be complicated due to the increase in the kind of the dyes, and the dyes should be used in at least the minimum amount to absorb a near infrared ray in each wavelength band. Therefore, the increase in the kind of the dyes may result in the increase in the total amount of the used dyes. That is to say, when the dyes are used in an increased amount, the cost of the filters may be increased and the transmittance of a visible ray in addition to the near infrared ray may be deteriorated due to the presence of the large amount of the dyes, which leads to the degraded quality of image.

Therefore, it is necessary to reduce the kind and amount of the dyes, and to provide a PDP filter having an ability to absorb a sufficient quantity of the near infrared ray even when only one dye is used, if necessary.

U.S. Pat. No. 5,804,102 discloses a plasma display filter that may operate as a PDP filter in a wavelength band of 800 to 900 nm. When the plasma display filter operates within the narrow wavelength bands, it is possible to use a smaller number of dyes than that described in the Japanese Patent Laid-open Publication No. 2004-309655, and therefore it is possible to partially solve the problems of the Japanese Patent Laid-open Publication No. 2004-309655. This technique may applicable when a receiver band of a remote controller is restricted to a wavelength range of 800 to 900 nm. However, when a filter has a wide receiver band of 800 to 1100 nm as in recently used remote controller receivers, the filter does not absorb light emitted at a wavelength range greater than 900 nm. Therefore, it may be difficult to prevent erroneous operation of the filter by the light emitted at the wavelength range.

Accordingly, any of the techniques that have been proposed up to date did not provided the solution that it is possible to prevent erroneous operations of equipments by the near infrared ray while maintaining a high visible ray transmittance even when a small amount of dye is used in the filters.

### DISCLOSURE OF INVENTION

### Technical Problem

The present invention has been made to solve the foregoing problems with the prior art, and therefore an aspect of the present invention is to provide a high-performance PDP filter for absorbing near infrared ray capable of minimizing a wavelength range for shielding a near infrared ray (NIR), and also maintaining an ability of a film for shielding a near infrared ray to prevent interference of transmitting/receiving signals of a remote controller by PDP to the same level as conventional films. In this case, the PDP filter has an advantage regarding the manufacturing cost since the dyes may be used in the minimum amount and/or number, and has an advantage that the loss of transmittance at the visible ray wavelength range is minimized due to the minimum use of the dyes.

### Technical Solution

According to an aspect of the present invention, there is provided a PDP filter for absorbing near infrared ray, comprising a dye whose maximum absorption wavelength to a near infrared ray ranges from 880 to 1000 nm.

In this case, the maximum absorption wavelength of the dye may range from 900 to 960 nm.

Also, the light transmittance in an 880 to 1000 nm wavelength range may be lower by at least 10% point than the light transmittance in an 800 to 880 nm wavelength range, and the light transmittance at 883 nm wavelength may be desirably lower by at least 10% point than the light transmittance at 824 nm wavelength.

Furthermore, the absolute value of difference between the light transmittance in an 880 to 920 nm wavelength range and the light transmittance in a 980 to 1000 nm wavelength range is 5% point or less.

The dye may be one or more selected from the group consisting of a cyanine-based dye, a phthalo/naphthalocyanine-based dye and a metal complex dye. And, the metal complex dye may be a compound represented by the following Formula 1 or 2:

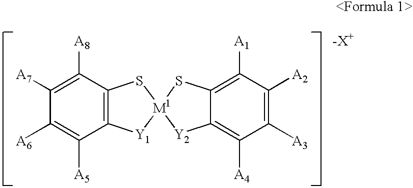

wherein, A1 to A8 are each independently hydrogen, halogen, nitro group, cyano group, thiocyanato group, cyanato group, acyl group, carbamoyl group, alkylaminocarbonyl group, alkoxycarbonyl group, aryloxycarbonyl group, substituted or unsubstituted alkyl group, substituted or unsubstituted aryl group, substituted or unsubstituted alkoxy group, substituted or unsubstituted aryloxy group, substituted or unsubstituted alkylthio group, substituted or unsubstituted arylthio group, substituted or unsubstituted alkylamino group, substituted or unsubstituted arylamino group, substituted or unsubstituted alkylcarbonylamino group, or substituted or unsubstituted arylcarbonylamino group, the substituent being halogen, alkoxy group having 1 to 5 carbon atoms, aryloxy group having 6 to 10 carbon atoms, or alkylamino group having 1 to 16 carbon atoms; Y1 and Y2 are each independently oxygen or sulfur; X⁺ represents quaternary ammonium or quaternary phosphonium; and M1 is nickel, platinum, palladium or copper, or

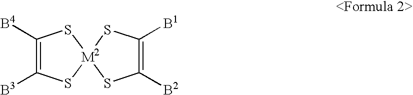

wherein, B1 to B4 are each independently hydrogen, cyano group, hydroxy group, nitro group, alkoxy group, aryloxy group, alkylthio group, fluoroalkyl group, acyl group, carbamoyl group, alkylaminocarbonyl group, alkoxycarbonyl group, aryloxycarbonyl group, substituted or unsubstituted aryl group, or substituted or unsubstituted naphthyl group, the substituent being a halogen, alkylthio group, alkoxy group having 1 to 5 carbon atoms, aryloxy group having 6 to 10 carbon atoms, or alkylamino group having 1 to 16 carbon atoms; and M2 is nickel, platinum, palladium or copper.

Also, the phthalocyanine dye may be a compound represented by the following Formula 3, and the naphthalocyanine dye may be a compound represented by the following Formula 4:

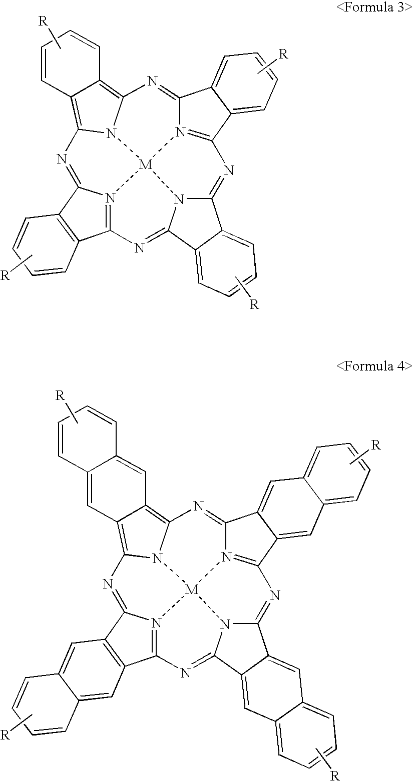

wherein, R is each independently hydrogen, halogen, substituted or unsubstituted alkyl group, substituted or unsubstituted aryl group, substituted or unsubstituted alkoxy group, substituted or unsubstituted aryloxy group, or substituted or unsubstituted five-membered rings having at least one nitrogen, the substituent being halogen, alkyl thio group, alkoxy group having 1 to 5 carbon atoms, aryloxy group having 6 to 10 carbon atoms, or alkylamino group having 1 to 16 carbon atoms.

Further more, the cyanine-based dye may be a compound represented by the following Formula 5:

Ar₁-A-Ar₂ <Formula 5>

wherein, A is substituted or unsubstituted hydrocarbylene group that has 5 to 7 carbon atoms and forms a conjugated double bond; and

Ar₁ and Ar₂ are each independently substituted or unsubstituted aryl group; substituted or unsubstituted heterocyclic group; or cyclic compound group containing a substituted or unsubstituted heterocyclic ring.

In this case, the A may be represented by the following Formula 6

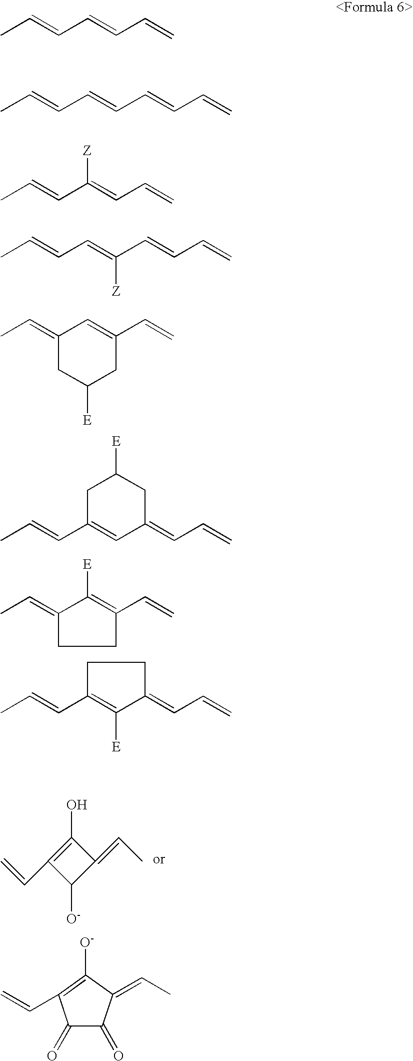

wherein E is halogen, nitro group, cyanine group, sulfonic acid group, sulfonate group, sulfonyl group, carboxyl group, alkoxycarbonyl group having 2 to 8 carbon atoms, phenoxycarbonyl group, carboxylate group, alkyl group having 1 to 8 carbon atoms, alkoxy group having 1 to 8 carbon atoms, or aryl group having 6 to 30 carbon atoms, and

Z is hydrogen, halogen, cyano group, alkyl group having 1 to 8 carbon atoms, or aryl group having 6 to 10 carbon atoms.

Also, the Ar₁ and Ar₂ ray be represented by the following Formula 7:

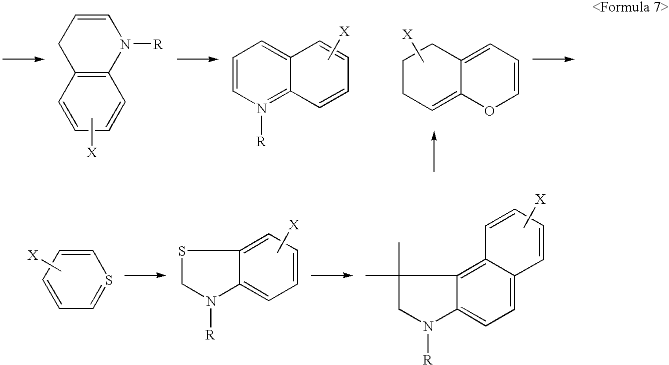

wherein a substituent X may be substituted with any of aromatic rings, and is selected from the group consisting of halogen, nitro group, cyanine group, sulfonic acid group, sulfonate group, sulfonyl group, carboxyl group, alkoxycarbonyl group having 2 to 8 carbon atoms, phenoxycarbonyl group, carboxylate group, alkyl group having 1 to 8 carbon atoms, alkoxy group having 1 to 8 carbon atoms, aryl group having 6 to 30 carbon atoms, etc.; R is each independently hydrogen, halogen, substituted or unsubstituted alkyl group, substituted or unsubstituted aryl group, substituted or unsubstituted alkoxy group, substituted or unsubstituted aryloxy group, or a substituted or unsubstituted five-membered ring having at least one nitrogen, and the substituent is halogen, alkylthio group, alkoxy group having 1 to 5 carbon atoms, aryloxy group having 6 to 10 carbon atoms, or alkylamino group having 1 to 16 carbon atoms.

Furthermore, the cyanine-based dye may be at least one selected from the group consisting of compounds represented by the following Formulas 8 to 15.

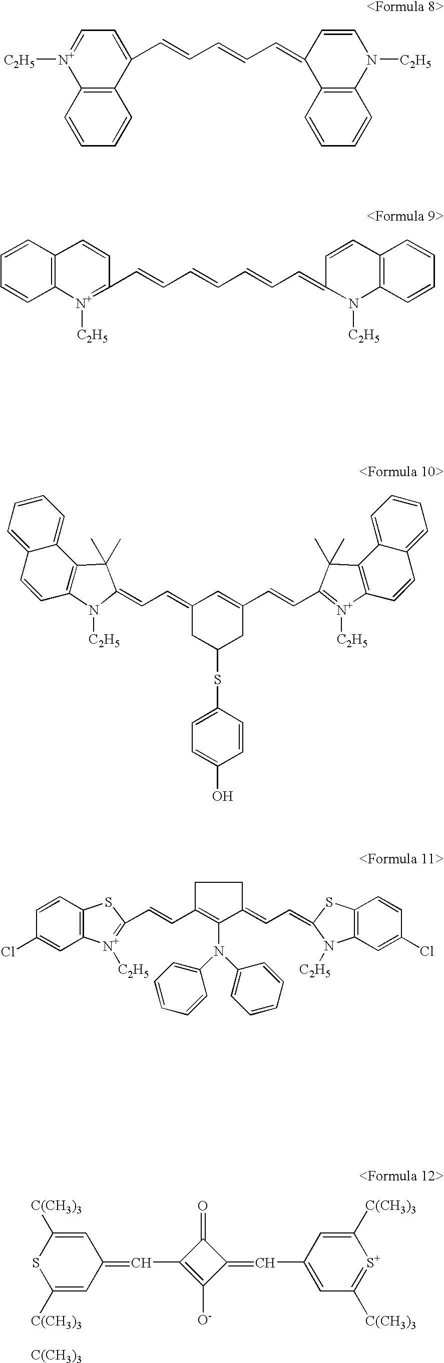

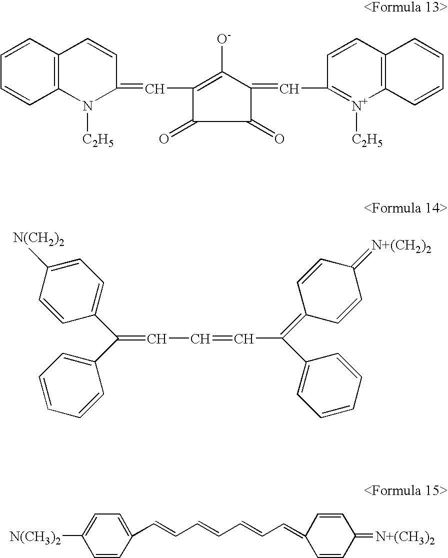

Also, the dye may be wet-coat onto a base material together with a solvent and a binder, and dried.

In this case, the solvent may be selected from the group consisting of methylethylketone (MEK), ethylacetate (EA) and toluene.

Also, the binder may include acrylic binders such as polymethyl methacrylate (PMMA), styrene-acrylonitrile (SAN) resin, and polycarbonate (PC).

In addition, an outer surface of the coating layer that is coated with a mixture of the dye, the solvent and the binder and dried may be further coated with a polymeric pressure sensitive adhesive (PSA).

Furthermore, the binder may include a polymeric pressure sensitive adhesive (PSA).

### ADVANTAGEOUS EFFECTS

An aspect of the present invention provides a PDP filter capable of absorbing a sufficient quantity of a near infrared ray even when small kinds of dyes are used compared to the conventional near infrared PDP filters using a large amount of dyes. Therefore, the PDP filter according to the present invention may be useful to improve its productivity, reduce the manufacturing cost and prevent the decrease in the light transmittance by unnecessary dyes.

### BRIEF DESCRIPTION OF THE DRAWINGS

FIG. 1 is a graph illustrating an electromagnetic wave generated in a PDP device at a predetermined wavelength range.

FIG. 2 is an enlarged graph illustrating an electromagnetic wave at a wavelength range of 700 to 1100 nm in the graph as shown in FIG. 1.

FIG. 3 is a graph illustrating a relative sensitivity to an infrared ray wavelength range of a remote controller receiver. Here, FIG. 3A shows the results of Model No. H 5110 (commercially available from Osram_SF), and FIG. 3B shows the results of Model No. PD410PI (commercially available from Sharp).

FIG. 4 is a graph illustrating transmittances to a wavelength range in the filters for absorbing a near infrared ray prepared according to Example of the present invention and Comparative example.

### BEST MODE FOR CARRYING OUT THE INVENTION

Hereinafter, exemplary embodiments of the present invention will be described in detail.

The present inventors have attempted to solve the problems regarding the filters known in the art, and found that the kind and number of used dyes are increased with a widening near infrared absorption wavelength band of a filter as described above. Also, it is necessary to find a condition in which an erroneous operation of filter peripheral equipment is prevented even when the filter absorbs a wavelength band that is as narrow as possible. Therefore, the present invention was completed on the basis of the above-mentioned facts.

Also, the present inventors have found that, in addition to the operating wavelength band of the PDP filter, a main wavelength range of a near infrared ray generated in the PDP device, and sensitivity of remote controller receivers in the filter peripheral equipment are also simultaneously taken into consideration to meet the requirements regarding the above-mentioned PDP filter.

That is to say, a remote controller receiving part in peripheral equipment of TV, air conditioner, video and the like (hereinafter, referred to as “peripheral equipment”) includes its own filter (a daylight filter) in a surface thereof so that it can shield most of an electromagnetic wave of a 750 nm or less wavelength to prevent disturbance caused by an electromagnetic wave (e.g., sun light, etc.) having a wavelength range other than the operating wavelength of the remote controller transmitting part. There is no problem caused by the electromagnetic wave of a 750 nm or less wavelength.

Therefore, the erroneous operation of the remote controller and the decrease in sensitivity are caused by the electromagnetic wave of an 800 to 1200 nm wavelength range that is emitted from different parts other than the remote controller transmitting part. In the respect of the remote controller receiving part, the near infrared ray emitted from the PDP is recognized as noises (or, interference signals) that prevent the recognition of signals that are transmitted from the remote controller transmitting part.

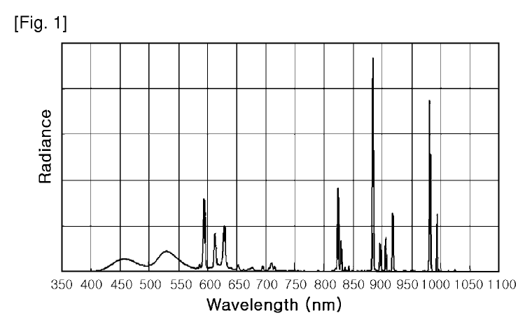

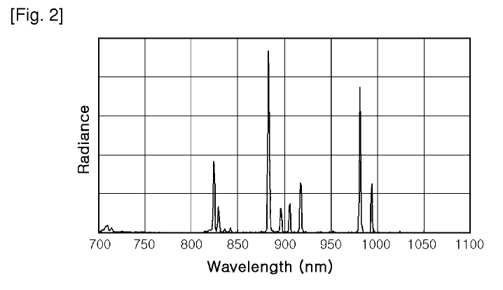

Herein, a spectrum of the near infrared ray emitted from the PDP was analyzed. The PDP used in this analysis is a 42-inch V5 panel from LG Electronics, and equipment used to measure the near infrared ray emitted from the PDP is an HR4000 spectrometer from Ocean Optics. The spectra of the measured near infrared ray were shown in FIGS. 1 and 2. In this case, distributions of near infrared radiance by peaks and wavelength ranges of the near infrared ray are listed in the following Table 1 and Table 2, respectively.

TABLE 1

| Peak of near infrared ray | | PDP radiance ratio* |
|---|---|---|
| 800~1000 | nm | 100% |
| 824 | nm | 13% |
| 829 | nm | 6% |
| 883 | nm | 29% |
| 896 | nm | 4% |
| 906 | nm | 5% |
| 917 | nm | 9% |
| 981 | nm | 24% |
| 994 | nm | 8% |

*The peak values listed in the Table 1 means radiance ratios of the respective NIR peaks on the assumption that the total amount of NIR emitted from a wavelength range of 800 to 1000 nm is 100 percent.

TABLE 2

| Wavelength range | | PDP radiance ratio* |
|---|---|---|
| 800~1000 | nm | 100% |
| 800~880 | nm | 19% |
| 880~920 | nm | 48% |
| 920~980 | nm | 1% |
| 980~1000 | nm | 32% |

*The wavelength values listed in the Table 2 means radiance ratios in the respective wavelength ranges on the assumption that the total amount of NIR emitted from a wavelength range of 800 to 1000 nm is 100 percent.

From the results as listed in the Tables 1 and 2, it was seen that the components of near infrared spectrum that causes the most of NIR noise in the PDP are peaks at wavelengths of 824, 883 and 981 nm, and the peaks at wavelengths of 883 and 981 nm are the highest among them. It was revealed that, when the measured data are divided depending on the wavelength ranges, the near infrared noise generated in the wavelength range of 880 to 1000 nm accounts for 81% of the total NIR noise.

The near infrared noise generated in the 800 to 880 nm wavelength range including the high peak of near infrared radiance at 824 nm wavelength accounts for about 19% of the total NIR noise, which is not so high but not negligible. However, another factor, e.g., the sensitivity of a remote controller receiving part, that affects the erroneous operation of the remote controller, is analyzed, depending on the wavelength ranges of the remote controller receiving part. As a result, it is possible to propose a PDP filter for absorbing a near infrared ray having a relatively narrower absorption wavelength range while maintaining the same performances.

That is to say, the receiving part of the remote controller uses an optical diode to detect a near infrared ray transmitted from a transmitting part of the remote controller. Here, although the optical diode has a wide photosensitive wavelength range of 400 to 1100 nm, the photo sensitivity of the receiving part is different, depending on the wavelength range. Therefore, even when a large amount of the electromagnetic wave reaches the optical diode, the optical diode reacts to a different extent according to the wavelength range of the electromagnetic wave, which leads to the erroneous operation of the remote controller to same different extent.

Therefore, although the electromagnetic wave is emitted in a large amount in a wavelength range having low sensitivity, the erroneous operation of the remote controller receiving part is not caused within the wavelength range. Therefore, it is not necessary to absorb a large amount of the electromagnetic wave with the wavelength range.

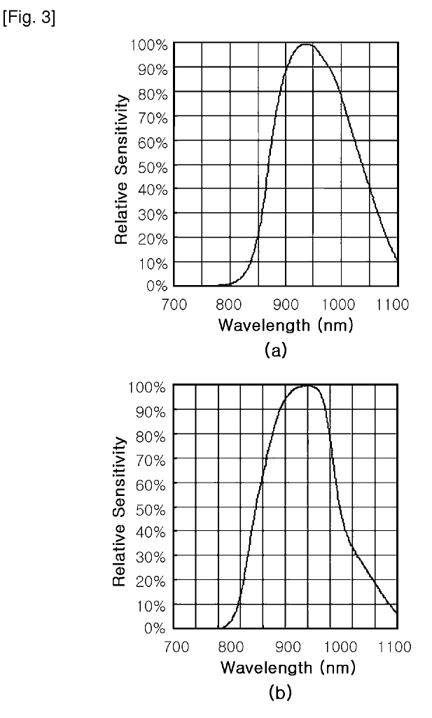

On the basis of the above-mentioned facts, the present inventors have obtained, compared to, and analyzed data about the photo sensitivity of the remote controller receiving part in each wavelength range. As a result, it was revealed that most of commercially available sensors in the remote controller light-receiving part have the highest sensitivity in a wavelength range of 880 to 1000 nm, and it has a sensitivity of 20% or less at an wavelength band of 880 nm or less. Among the sensors, a sensor of a light-receiving part having a relatively higher band of the maximum sensitivity wavelength (Model No. PD410PI from Sharp, the maximum sensitivity wavelength=1000 nm and a sensor of a light-receiving part having a relatively lower band of the maximum sensitivity wavelength (Model No. H 5110 from Osram_SF, the maximum sensitivity wavelength=940 mm were used to plot a curve of the photo sensitivity of the sensors in each wavelength range by employing a manufacturers data sheet). The results are listed in the following FIG. 3 and Table 3.

TABLE 3

| Wavelength range | | Sharp PD410PI | Osram_SFH 5110 |
|---|---|---|---|
| 800~1000 | nm | 55.4% | 62.2% |
| 800~880 | nm | 13.3% | 19.9% |
| 880~920 | nm | 63.3% | 85.7% |
| 920~980 | nm | 92.1% | 96.4% |
| 980~1000 | nm | 99.4% | 83.8% |

The wavelength values listed in the Table 3 means average values of the relative sensitivity in the respective wavelength ranges on the assumption that the sensor has a sensitivity of 100 as measured at the wavelength having the highest sensitivity.

As listed in the Table 3, it was revealed that a mean photo sensitivity in the 800 to 1000 nm wavelength range, which corresponds to a wavelength range that reaches the remote controller receiving part, in the entire wavelength range emitted from the PDP device is about 55 to 62%, but the photo sensitivities are significantly different depending on each of the wavelength bands. Therefore, it was revealed that the sensors have a low sensitivity of 13.3 to 19.9% in the 800 to 880 nm wavelength range that accounts for 19% of the total NIR generated in the PDP device, and has a sensitivity of 63.3% or more at the 880 to 1000 nm wavelength bands. Also, it was particularly seen that the sensors has an extremely high photo sensitivity of 80% or more in the 980 to 1000 nm wavelength range that accounts for 32% of the total NIR generated in the PDP device.

As listed in the Table 2, it was seen that the major wavelength band of PDP NIR may be divided into three sub-wavelength bands of 800 to 880 nm, 880 to 920 nm, and 980 to 1000 nm. Putting together these results and the results of Table 3 listing the received sensitivities of the remote controller receiving part at the respective wavelength ranges, it was confirmed that the PDP filter may determine a wavelength band to be shielded or not to be shielded.

That is to say, on the basis of the results from the Tables 1 and 2 and the results from the Table 3, it was anticipated that the peripheral equipment may not operate erroneously since the light having an 824 nm wavelength band in the electromagnetic wave emitted from the PDP device is not high in the total NIR (about 19%) and the sensitivities are low in the remote controller light-receiving part although a small amount of the electromagnetic wave is filtered by the PDP filter. On the contrary, it was anticipated that the peripheral equipment may operate erroneously to the extremely high extent in the wavelength ranges of 880 to 920 nm and 980 to 1000 nm since a large amount of the light is generated in the wavelength ranges of 880 to 920 nm and 980 to 1000 nm and the remote controller also has a high sensitivity at the wavelength ranges.

Therefore, it was revealed that it is necessary to mainly shield the light of the wavelength range of 880 to 920 nm and 980 to 1000 nm wavelengths, which has a high photo sensitivity while emitting the largest amount of the near infrared ray.

Accordingly, the PDP filter for absorbing near infrared ray according to the present invention has the maximum absorption wavelength (e.g., the minimum transmission wavelength) at the 880 to 1000 nm wavelength band. As described above, the maximum absorption wavelength preferably ranges from 880 to 1000 nm, and more preferably from 900 to 960 nm, considering the fact that the emission of the near infrared ray is highest at the 883 nm wavelength band as described above, and the adsorbancy index of the light at the other wavelength bands. When the PDP filter has the maximum absorption wavelength at the narrow wavelength range as described above, it is possible to reduce the kind of the dyes, and it is preferred to use only one kind of dye.

However, the number of the dyes is a more preferred embodiment of the present invention, but there is no need to use only one dye. That is to say, various kinds of dyes are added in a large amount to provide a PDP filter having a constant adsorbancy index in the entire wavelength range, and therefore the conventional PDP filter has problems such as the increase in the total amount of the added dyes. However, the present invention, which are different from the prior art, is characterized in that the dyes used in the present invention have a narrow band of the maximum absorption wavelength, and at least two dyes act to compensate for their weak points when they are used in the manufacture of the PDP filter, and therefore the total amount of the added dyes is not increased since one added dye is reduced in amount as much as an amount of another added dye.

Also, it is considered that, since the absorption curve is in a continuous shape although the PDP filter has the maximum absorption wavelength range at 880 to 1000 nm wavelength, and preferably 900 to 960 nm wavelength, it should not be able to completely exclude the absorption of the near infrared ray of the other wavelength ranges. Therefore, the transmittance at the 800 to 880 nm wavelength range may be restricted to a proper level that is less than the level to cause equipment erroneous operation.

The PDP filter for absorbing near infrared ray according to the present invention has the minimum transmittance at the 880 to 1000 nm wavelength range as described above. In particular, the average transmittance at the 880 to 1000 nm wavelength range is lower by 10% point or more than that at the 800 to 880 nm wavelength range.

According to the research results by the present inventors, it is also possible to compare the transmittance for the light of an 883 nm wavelength band to the transmittance for the light of an 824 nm wavelength band for convenience sake. That is to say, since most of the light emitted from the PDP device has peaks around the 883 and 824 nm wavelength as described above, the reference transmittance of the PDP filter for absorbing near infrared ray may be set by determining the transmittances at the two wavelength bands.

Furthermore, the light, which has the wavelength ranges of 880 to 920 nm and 980 to 1000 nm wavelengths among the 880 to 1000 nm wavelength ranges, should be mainly shielded, as described previously. As a result, the cut-off rates of the light at the two wavelength bands should be maintained at a high similar level, that is, the transmittances of the light at the two wavelength bands should be maintained at a low similar level. Accordingly, absolute value of difference in the transmittance of the PDP filter for the light of the two wavelength bands is preferably restricted to 5% point or less.

For the PDP filter having the above-mentioned physical properties, the dye, which may be used herein, includes at least one selected from the group consisting of cyanine-bases dye, phthalo/naphthalocyanine-based dye, metal complex dye, etc.

And, the metal complex dye is preferably a compound represented by the following Formula 1 or 2.

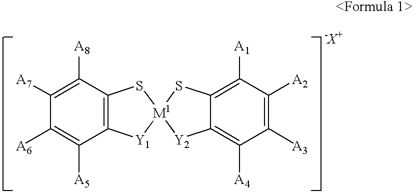

wherein, A1 to A8 are each independently hydrogen, halogen, nitro group, cyano group, thiocyanato group, cyanato group, acyl group, carbonyl group, alkylaminocarbonyl group, alkoxycarbonyl group, aryloxycarbonyl group, substituted or unsubstituted alkyl group, substituted or unsubstituted aryl group, substituted or unsubstituted alkoxy group, substituted or unsubstituted aryloxy group, substituted or unsubstituted alkylthio group, substituted or unsubstituted arylthio group, substituted or unsubstituted alkylamino group, substituted or unsubstituted arylamino group, substituted or unsubstituted alkylcarbonylamino group, or substituted or unsubstituted arylcarbonylamino group, the substituent being halogen, alkoxy group having 1 to 5 carbon atoms, aryloxy group having 6 to 10 carbon atoms, or alkylamino group having 1 to 16 carbon atoms; Y1 and Y2 are each independently oxygen or sulfur; X⁺ represents quaternary ammonium or quaternary phosphonium; and M1 is nickel, platinum, palladium or copper, or

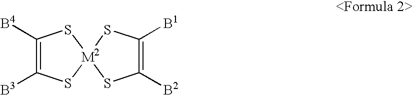

wherein, B1 to B4 are each independently hydrogen, cyano group, hydroxy group, nitro group, alkoxy group, aryloxy group, alkylthio group, fluoroalkyl group, acyl group, carbamoyl group, alkylaminocarbonyl group, alkoxycarbonyl group, aryloxycarbonyl group, substituted or unsubstituted aryl group, or substituted or unsubstituted naphthyl group, the substituent being a halogen, alkylthio group, alkoxy group having 1 to 5 carbon atoms, aryloxy group having 6 to 10 carbon atoms, or alkylamino group having 1 to 16 carbon atoms; and M2 is nickel, platinum, palladium or copper.

Also, the phthalocyanine dye is preferably a compound represented by the following Formula 3, and the naphthalocyanine dye is preferably a compound represented by the following Formula 4:

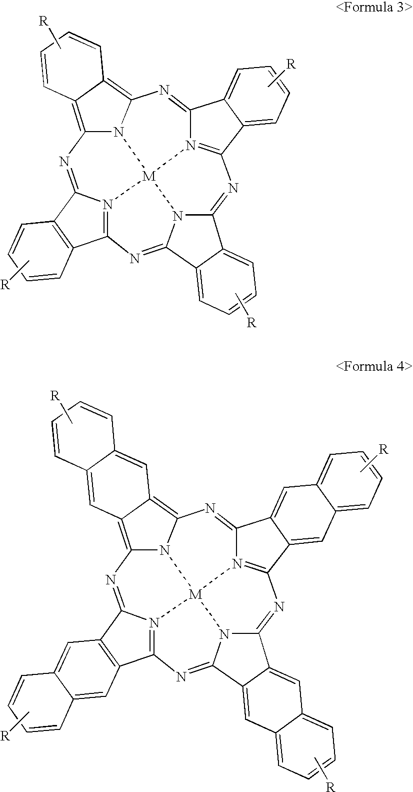

wherein, R is each independently hydrogen, halogen, substituted or unsubstituted alkyl group, substituted or unsubstituted aryl group, substituted or unsubstituted alkoxy group, substituted or unsubstituted aryloxy group, or substituted or unsubstituted five-membered rings having at least one nitrogen, the substituent being halogen, alkyl thio group, alkoxy group having 1 to 5 carbon atoms, aryloxy group having 6 to 10 carbon atoms, or alkylamino group having 1 to 16 carbon atoms.

Furthermore, the cyanine-based dye is preferably a compound represented by the following Formula 5:

Ar₁-A-Ar₂ <Formula 5>

wherein, A is substituted or unsubstituted hydrocarbylene group that has 5 to 7 carbon atoms and forms a conjugated double bond; and

Ar₁ and Ar₂ are each independently substituted or unsubstituted aryl group; substituted or unsubstituted heterocyclic group; or cyclic compound group containing a substituted or unsubstituted heterocyclic ring.

Here, the A may include compounds that are more particularly represented by the following Formula 6

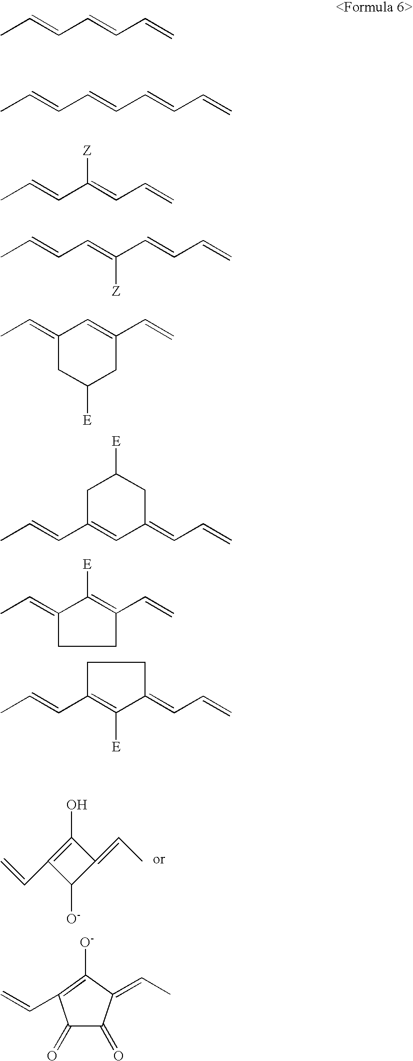

wherein E is halogen, nitro group, cyanine group, sulfonic acid group, sulfonate group, sulfonyl group, carboxyl group, alkoxycarbonyl group having 2 to 8 carbon atoms, phenoxycarbonyl group, carboxylate group, alkyl group having 1 to 8 carbon atoms, alkoxy group having 1 to 8 carbon atoms, or aryl group having 6 to 30 carbon atoms, and

Z is hydrogen, halogen, cyano group, alkyl group having 1 to 8 carbon atoms, or aryl group having 6 to 10 carbon atoms.

Also, the Ar₁ and Ar₂ may include compounds that are more particularly represented by the following Formula 7:

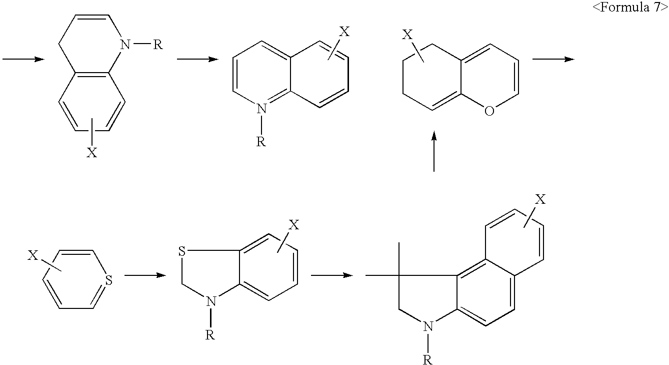

wherein a substituent X may be substituted with any of aromatic rings, and is selected from the group consisting of halogen, nitro group, cyanine group, sulfonic acid group, sulfonate group, sulfonyl group, carboxyl group, alkoxycarbonyl group having 2 to 8 carbon atoms, phenoxycarbonyl group, carboxylate group, alkyl group having 1 to 8 carbon atoms, alkoxy group having 1 to 8 carbon atoms, aryl group having 6 to 30 carbon atoms, etc.; and R is each independently hydrogen, halogen, substituted or unsubstituted alkyl group, substituted or unsubstituted aryl group, substituted or unsubstituted alkoxy group, substituted or unsubstituted aryloxy group, or a substituted or unsubstituted five-membered ring having at least one nitrogen, the substituent being halogen, alkylthio group, alkoxy group having 1 to 5 carbon atoms, aryloxy group having 6 to 10 carbon atoms, or alkylamino group having 1 to 16 carbon atoms.

The cyanine-based dye, which may be used herein, may preferably include at least one compound selected from the group consisting of compounds represented by the following Formulas 8 to 15.

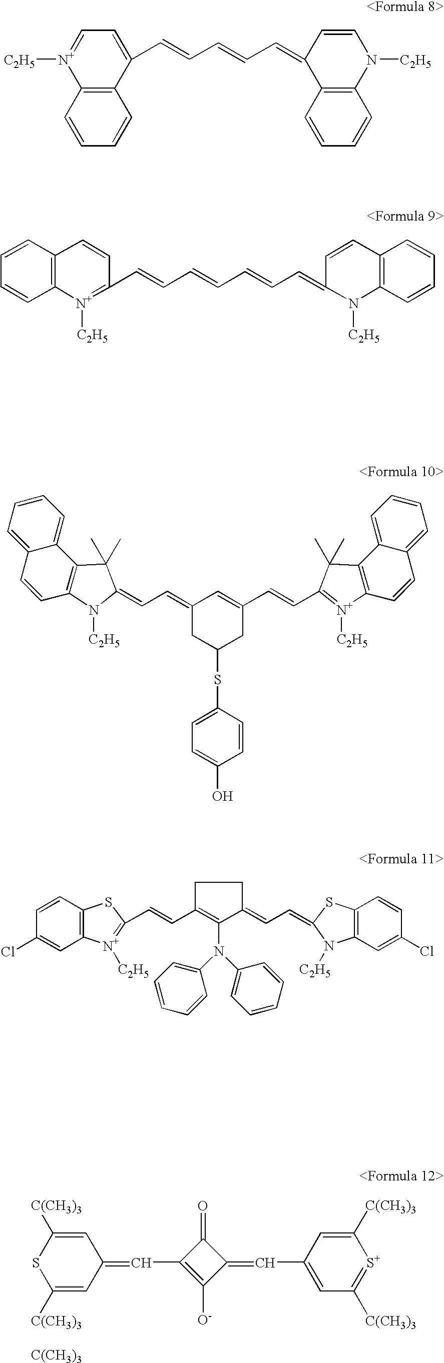

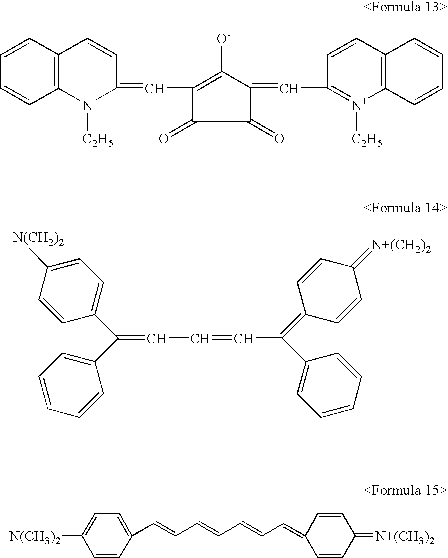

Furthermore, polyethylene terephthalate (PET) is preferably used as the base material, and the dye is preferably used in the form of coating on the base material. The wet coating process may be used, including: coating a base material with the dye together with a binder and a solvent such as methylethylketone (MEK) and ethylacetate (EA), toluene, and drying the coating. The binder used herein includes acrylic binders (for example, polymethyl methacrylate (PMMA), etc.), styrene-acrylonitrile (SAN) resin, and polycarbonate (PC), and it is preferred to use an polymeric pressure sensitive adhesive (PSA) as the binder. When other binders are used instead of the PSA, an outer surface of a coating layer is generally further coated with an adhesive such as PSA to give adhesivity. However, when the PSA is used as the binder, it is unnecessary to further coat a coating layer with the adhesive since the binder itself has adhesivity.

The coating layer has a preferable thickness of 3 to 20 μm, which is sufficient to show an ability to absorb a near infrared ray when the dye is coated in the wet coating process. In particular, the coating layer has a preferable thickness of 20 to 30 μm when the PSA is used as the binder.

### MODE FOR THE INVENTION

### Example

A 100 μm-thick PET base material was coated at a thickness of about 250 μm with a mixture prepared by mixing 89 g of a solvent (including methylethylketone (MEK)), 140 mg of a phthalocyanine-based dye ‘910B’ (Nippon Catalyst Co.) with the maximum absorption wavelength of 958 nm, 53 mg of a phthalocyanine-based dye ‘906B’ with the maximum absorption wavelength of 911 nm, and 11 g of a binder ‘acrylic PSA,’ and then dried at 120° C. for 5 minutes to prepare a film for absorbing a near infrared ray according to the present invention. In this case, the film according to the present invention has a thickness of 25 μm.

### Comparative Example

In order to absorb the entire wavelength range of 800 to 1200 nm, 600 mg of a diimmonium-based dye ‘CIR 1081’ (commercially available from Japan Carlit) and 300 mg of a metal complex dye ‘V-63’ (commercially available from Epolin), both of which have the light absorption wavelengths of about 1100 nm and 850 nm respectively, were mixed with 30 g of an acrylic binder with a glass transition temperature (Tg) of 90° C. or above, and 70 g of a methylethylketone solvent. Then, the resulting mixture was dried to prepare a film for absorbing a near infrared ray, which has a thickness of 10 μm. For the prepared PDP filter for absorbing near infrared ray, the resulting coating layer has a thickness of 10 μm.

The PDP filter for absorbing near infrared ray was tested for an ability to absorb a near infrared ray, as follows.

1. Transmittance for the near infrared ray in each wavelength range is calculated as a ratio of the difference between amounts of the emitted near infrared ray when a filter is used and when a filter is not used by comparing the results obtained by measuring the amounts of the emitted near infrared ray when a filter is used and when a filter is not used. Near infrared radiance at each wavelength band were measured using a spectrometer HR4000 (from Ocean Optics). The respective radiances were represented by fractions when the radiance in the entire wavelength range is set to 100, as described above.

2. An amount of the light detected by a sensor was calculated in consideration of a curve of sensitivities of a remote controller receiving part at each wavelength range, the remote controller receiving part being made of Model No. PD410PI (purchased from Sharp) and Model No. H 5110 (purchased from Osram_SF).

3. Transmittance of the films was measured using a uv-vis spectrometer (Model name: uv3101, purchased from Shirnadzu).

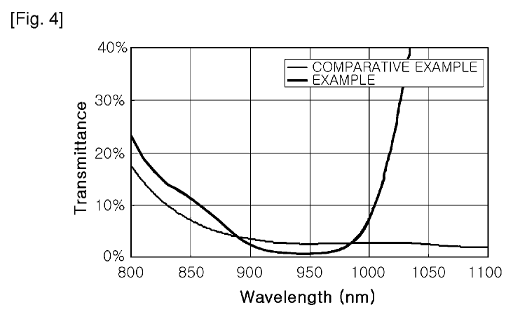

The transmittances to the wavelengths of the filters for absorbing a near infrared ray, prepared respectively in the Example and Comparative example, were compared, as shown in a graph of FIG. 4.

As shown in the graph of FIG. 4, the various kinds of the dyes were used to reduce the transmittance at the entire wavelength band of 800 nm wavelength or more, so that the filter prepared in the Comparative example can have a constant ability to absorb a near infrared ray in the entire wavelength range of 800 nm wavelength or more. On the contrary, the filter prepared in the Example was designed to absorb a lager amount of the near infrared ray having a wavelength range of 880 to 1000 nm (more preferably, 900 to 960 mm).

The near infrared absorption test results on the PDP filters prepared in the Example and Comparative example are listed in the following Table 4.

TABLE 4

| | | | Photo Sensitivity | | Transmittance | | NIR noise detected in | | | |
|---|---|---|---|---|---|---|---|---|---|---|
| | | Emission* | of remote control | | of PDP | | remote control sensor after | | | |
| | | of | sensor (%) | | filter | | passage of filter (%) | | | |
| | | PDP | Sharp | Osram_SFH | | Comp. | Ex. | | Comp. Ex. | |
| Wavelength | | NIR | PD410PI | 5110 | Ex. | Ex. | Sharp | Osram | Sharp | Osram |
| Entire | 800~1000 nm | 100* | 55.4 | 62.2 | 6.5 | 5.5 | 3.6 | 3.7 | 3.6 | 3.7 |
| range | | | | | | | | | | |
| Each | 800~880 nm | 19 | 13.3 | 19.9 | 13.1 | 9.3 | 0.2 | 0.3 | 0.1 | 0.2 |
| band | 880~920 nm | 48 | 63.3 | 85.7 | 2.7 | 3.5 | 1.7 | 2.1 | 1.9 | 2.3 |
| range | 920~980 nm | 1 | 92.1 | 96.4 | 0.9 | 2.7 | 0.1 | 0.1 | 0.2 | 0.1 |
| | 980~1000 nm | 32 | 99.4 | 83.8 | 4.3 | 2.8 | 1.6 | 1.2 | 1.4 | 1.1 |
| | 880~1000 | 81 | 83.7 | 90.8 | 2.1 | 3.0 | 3.4 | 3.4 | 3.5 | 3.5 |
| | 1000~1050 nm | 0 | 93.9 | 59.2 | 30.1 | 2.8 | 0 | 0 | 0 | 0 |

*It is assumed that the total amount of a near infrared ray generated at an 800 to 1000 nm wavelengths is 100.

As listed in the Table 2, it was revealed that the filter (Example) for absorbing a near infrared ray according to the present invention has an increased transmittance at an 800 to 880 nm wavelength band and a decreased transmittance at an 880 to 920 nm wavelength band, compared to the conventional filter (Comparative example). In this case, it is anticipated that, when the near infrared ray with the same radiance is emitted from the PDP device, the intensities of the near infrared ray detected in the remote controller light-receiving part was 3.6% and 3.7% in the case of the Example, and 3.6% and 3.7% in the case of the Comparative example, indicating that there is no difference between the two PDP filters of the Example and the Comparative example. This is why an effect of the near infrared ray emitted from the PDP device on the remote controller receiving part may be minimized by intensively shielding an 880 to 920 nm wavelength range at the cost of the near infrared shielding characteristics at the 800 to 880 nm wavelength range in which the remote controller sensor has a low sensitivity.

Accordingly, it was confirmed that the PDP filter for absorbing near infrared ray according to the present invention using a small amount of dyes (preferably, one kind of dye) has excellent effect to operate at the narrow wavelength ranges as described above.

1. A PDP filter for absorbing near infrared ray, comprising a dye whose maximum absorption wavelength to a near infrared ray ranges from 880 to 1000 nm.

2. The PDP filter of claim 1, wherein the maximum absorption wavelength of the dye ranges from 900 to 960 nm.

3. The PDP filter of claim 1, wherein the light transmittance in an 880 to 1000 nm wavelength range is lower by at least 10% point than the light transmittance in an 800 to 880 nm wavelength range.

4. The PDP filter of claim 3, wherein the light transmittance at 883 nm wavelength is lower by at least 10% point than the light transmittance at 824 nm wavelength.

5. The PDP filter of claim 1, wherein the absolute value of difference between the light transmittance in an 880 to 920 nm wavelength range and the light transmittance in a 980 to 1000 nm wavelength range is 5% point or less.

6. The PDP filter of claim 1, wherein the dye is one or more selected from the group consisting of a cyanine-based dye, a phthalo/naphthalocyanine-based dye and a metal complex dye.

7. The PDP filter of claim 6, wherein the metal complex dye is a compound represented by the following Formula 1 or 2: 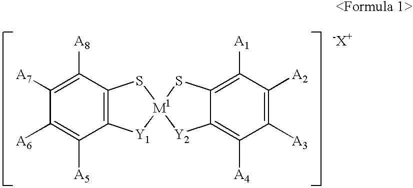
wherein, A1 to A8 are each independently hydrogen, halogen, nitro group, cyano group, thiocyanato group, cyanato group, acyl group, carbamoyl group, alkylaminocarbonyl group, alkoxycarbonyl group, aryloxycarbonyl group, substituted or unsubstituted alkyl group, substituted or unsubstituted aryl group, substituted or unsubstituted alkoxy group, substituted or unsubstituted aryloxy group, substituted or unsubstituted alkylthio group, substituted or unsubstituted arylthio group, substituted or unsubstituted alkylamino group, substituted or unsubstituted arylamino group, substituted or unsubstituted alkylcarbonylamino group, or substituted or unsubstituted arylcarbonylamino group, the substituent being halogen, alkoxy group having 1 to 5 carbon atoms, aryloxy group having 6 to 10 carbon atoms, or alkylamino group having 1 to 16 carbon atoms; Y1 and Y2 are each independently oxygen or sulfur; X⁺ represents quaternary ammonium or quaternary phosphonium; and M1 is nickel, platinum, palladium or copper, or 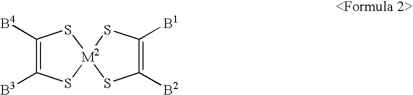
wherein, B1 to B4 are each independently hydrogen, cyano group, hydroxy group, nitro group, alkoxy group, aryloxy group, alkylthio group, fluoroalkyl group, acyl group, carbamoyl group, alkylaminocarbonyl group, alkoxycarbonyl group, aryloxycarbonyl group, substituted or unsubstituted aryl group, or substituted or unsubstituted naphthyl group, the substituent being a halogen, alkylthio group, alkoxy group having 1 to 5 carbon atoms, aryloxy group having 6 to 10 carbon atoms, or alkylamino group having 1 to 16 carbon atoms; and M2 is nickel, platinum, palladium or copper.

8. The PDP filter of claim 6, wherein the phthalocyanine dye is a compound represented by the following Formula 3, and the naphthalocyanine dye is a compound represented by the following Formula 4: 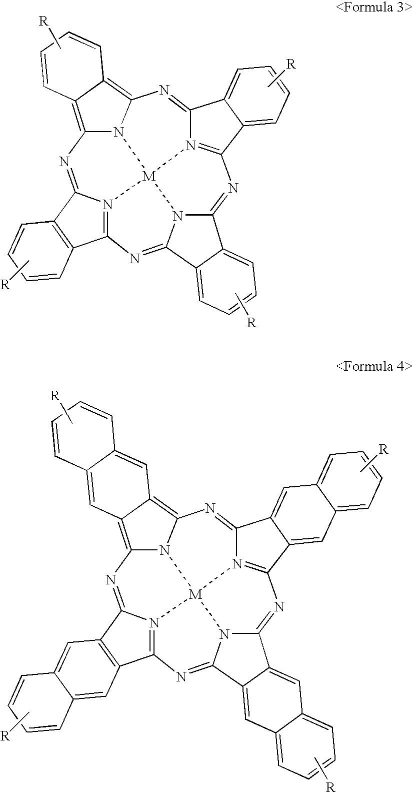
wherein, R is each independently hydrogen, halogen, substituted or unsubstituted alkyl group, substituted or unsubstituted aryl group, substituted or unsubstituted alkoxy group, substituted or unsubstituted aryloxy group, or substituted or unsubstituted five-membered rings having at least one nitrogen, the substituent being halogen, alkyl thio group, alkoxy group having 1 to 5 carbon atoms, aryloxy group having 6 to 10 carbon atoms, or alkylamino group having 1 to 16 carbon atoms.

9. The PDP filter of claim 6, wherein the cyanine-based dye is a compound represented by the following Formula 5:
Ar₁-A-Ar₂ <Formula 5>
wherein, A is substituted or unsubstituted hydrocarbylene group that has 5 to 7 carbon atoms and forms a conjugated double bond; and
Ar₁ and Ar₂ are each independently substituted or unsubstituted aryl group; substituted or unsubstituted heterocyclic group; or cyclic compound group containing a substituted or unsubstituted heterocyclic ring.

10. The PDP filter of claim 9, wherein the A is represented by the following Formula 6 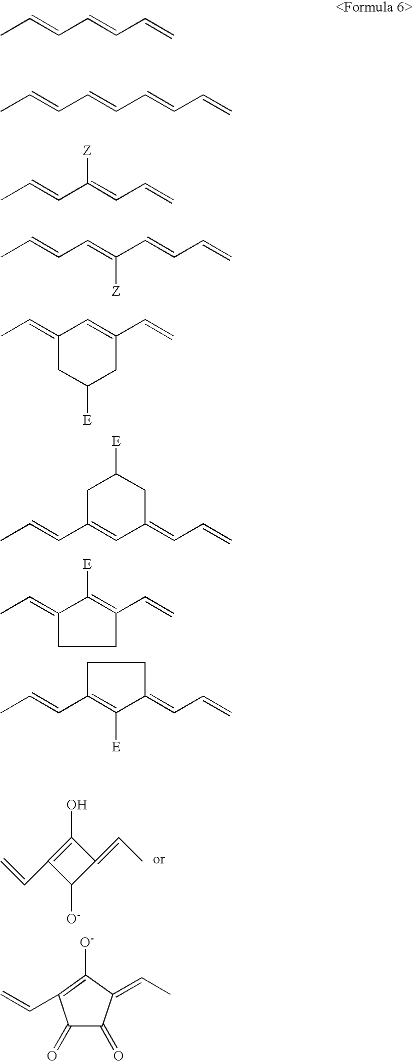
wherein E is halogen, nitro group, cyanine group, sulfonic acid group, sulfonate group, sulfonyl group, carboxyl group, alkoxycarbonyl group having 2 to 8 carbon atoms, phenoxycarbonyl group, carboxylate group, alkyl group having 1 to 8 carbon atoms, alkoxy group having 1 to 8 carbon atoms, or aryl group having 6 to 30 carbon atoms, and
Z is hydrogen, halogen, cyano group, alkyl group having 1 to 8 carbon atoms, or aryl group having 6 to 10 carbon atoms.

11. The PDP filter of claim 9, wherein the Ar₁ and Ar₂ are represented by the following Formula 7: 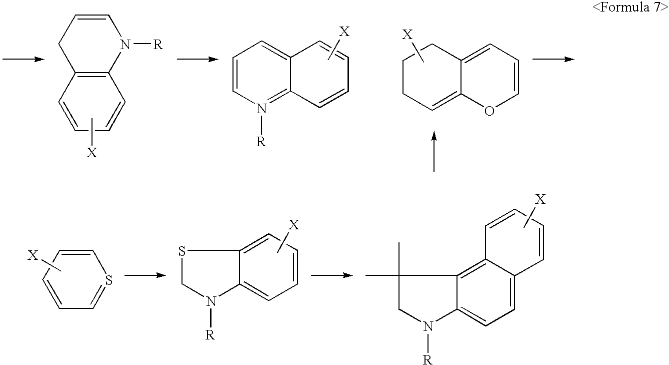
wherein a substituent X may be substituted with any of aromatic rings, and is selected from the group consisting of halogen, nitro group, cyanine group, sulfonic acid group, sulfonate group, sulfonyl group, carboxyl group, alkoxycarbonyl group having 2 to 8 carbon atoms, phenoxycarbonyl group, carboxylate group, alkyl group having 1 to 8 carbon atoms, alkoxy group having 1 to 8 carbon atoms, aryl group having 6 to 30 carbon atoms, etc.; and R is each independently hydrogen, halogen, substituted or unsubstituted alkyl group, substituted or unsubstituted aryl group, substituted or unsubstituted alkoxy group, substituted or unsubstituted aryloxy group, or a substituted or unsubstituted five-membered ring having at least one nitrogen, the substituent being halogen, alkylthio group, alkoxy group having 1 to 5 carbon atoms, aryloxy group having 6 to 10 carbon atoms, or alkyl amino group having 1 to 16 carbon atoms.

12. The PDP filter of claim 6, wherein the cyanine-based dye is at least one selected from the group consisting of compounds represented by the following Formulas 8 to 15.

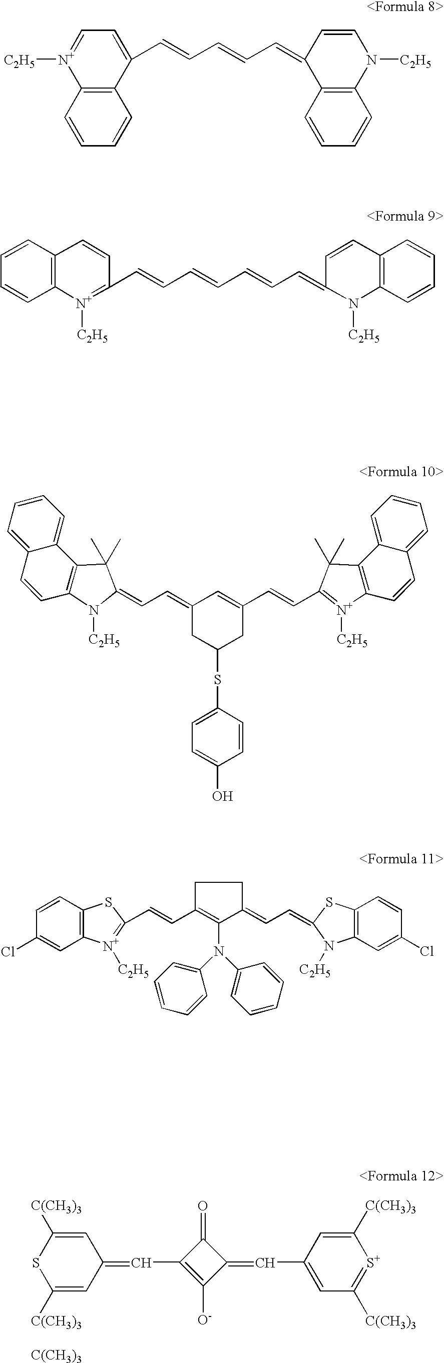

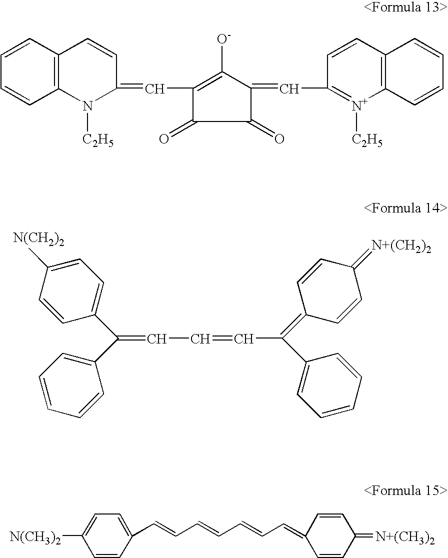

13. The PDP filter of claim 6, wherein the dye is wet-coated onto a base material together with a solvent and a binder and dried.

14. The PDP filter of claim 13, wherein the solvent is selected from the group consisting of methylethylketone (MEK), ethyl acetate (EA) and toluene.

15. The PDP filter of claim 13, wherein the binder includes acrylic binders such as polymethyl methacrylate (PMMA), styrene-acrylonitrile (SAN) resin, and polycarbonate (PC).

16. The PDP filter of claim 15, wherein an outer surface of the coating layer that is coated with a mixture of the dye, the solvent and the binder and dried is further coated with a polymeric pressure sensitive adhesive (PSA).

17. The PDP filter of claim 13, wherein the binder includes a polymeric pressure sensitive adhesive (PSA).
